(19) United States
(12) Patent Application Publication
(10) Pub. No.: US 2009/0253044 A1
(43) Pub. Date: Oct. 8, 2009

(54) Nonaqueous Electrolyte and Lithium ion Secondary Battery Using Same

(75) Inventors: Hidenobu Nogi, Chiba (JP); Akio Hiwara, Chiba (JP)

Correspondence Address: BUCHANAN, INGERSOLL & ROONEY PC, POST OFFICE BOX 1404, ALEXANDRIA, VA, 22313-1404, US

(73) Assignee: MITSUI CHEMICALS, INC., Minato-ku (JP)

(21) Appl. No.: 12/083,504

(22) PCT Filed: Oct. 10, 2006
(86) PCT No.: PCT/JP2006/320213

§ 371 Date: Apr. 11, 2008

(30) Foreign Application Priority Data
Oct. 12, 2005 (JP) 2005-297396

(51) Int. Cl. H01M 6/14

(52) U.S. Cl. 429/326

(57) ABSTRACT

Obtained are a nonaqueous electrolyte solution suitable for a lithium secondary battery having a high energy density, wherein a decrease in the capacity due to charge/discharge cycles is remarkably small and no gas is generated when charging or storing the battery; and a lithium secondary battery using the same. This nonaqueous electrolyte solution is a solution containing a nonaqueous solvent, the nonaqueous solvent containing a fluorinated solvent including a linear fluorinated carbonate (a1) and a fluorinated ethylene carbonate (a2), and the total amount of the fluorinated solvent in the nonaqueous solvent is in the range of from 50 to 100 weight %.

### TECHNICAL FIELD

The present invention relates to an electrolyte solution for use in a lithium secondary battery having a high energy density that exhibits a low degree of capacity decrease due to charge/discharge cycles.

### BACKGROUND ART

Lithium batteries are widely used as power sources for consumer electronic instruments because of their high levels of voltage and energy density and their high reliability such as in storage stability.

A typical example of a lithium battery is a lithium ion secondary battery, a battery composed of a negative electrode containing, as an active material, a carbon material capable of storing and releasing lithium; a positive electrode containing, as an active material, a composite oxide of lithium and a transition metal; and a nonaqueous electrolyte solution.

The nonaqueous electrolyte solution here has the role of transferring ions between the positive electrode and the negative electrode. In order to enhance the charge/discharge performance of the battery, it is necessary to increase the transfer rate of ions between the positive and negative electrodes as much as possible. For this purpose, measures are necessary such as increasing the ion conductivity of the nonaqueous electrolyte solution and lowering the viscosity of the nonaqueous electrolyte solution. On the other hand, in order to improve properties such as storability and cycle stability of the battery, the nonaqueous electrolyte solution needs to be stable with respect to the positive and negative electrodes, whose chemical and electrochemical reactivities are high.

Examples of the nonaqueous electrolyte solution satisfying such requirements as mentioned above may include, in cases of lithium ion batteries, a solution including a lithium salt such as LiPF₆ dissolved in a mixed solvent of a cyclic ester such as propylene carbonate, ethylene carbonate or γ-butyrolactone, and a linear ester such as diethyl carbonate, methyl ethyl carbonate, dimethyl carbonate, or methyl propionate. Further, it is reported that the charge/discharge performance of batteries is improved by adding a compound having a carbon-carbon unsaturated bond to the nonaqueous electrolyte solution, or including ethylene carbonate having a hydrogen atom substituted by a fluorine atom to the nonaqueous electrolyte solution (see, for example, Japanese Patent Application Laid-Open (JP-A) No. 62-290072, and Japanese Patent Application National Publication (Laid-Open) No. 2001-501355). The reason why the charge/discharge cycle characteristic is improved by these conventional techniques is thought to be that the electrochemical stability of the nonaqueous electrolyte solution toward the negative electrode is improved.

In the meantime, along with recent remarkable advances in the functionality of portable instruments, the development of a battery having an even higher energy density than those of conventional lithium ion batteries is greatly desired. As such a battery is suggested, for example, a lithium battery employing a negative electrode active material containing an element that can form a compound or a solid solution with lithium, the element being selected from the groups 12 (IIB), 13 (IIIB), 14 (IVB), and 15 (VB) in the periodic table, and being able to form an alloy with lithium electrochemically when charging the battery, and the like (hereinafter, referred to as an “alloy-type lithium-ion secondary battery”) (see, for example, Solid State Ionics, 113-115, p. 57 (1998)). Such a negative electrode active material enables the storage amount of lithium per unit volume to increase to a significant level, as compared with the carbon material conventionally used as a negative electrode active material of lithium ion batteries, thereby remarkably improving the energy density of the batteries. However, since this negative active material undertakes significant changes in volume upon charge/discharge (expansion due to storing of lithium/shrinkage due to releasing lithium), and when this happens an active face of the negative active material, a face that decomposes the nonaqueous electrolyte solution, tends to appear on the surface in contact with the nonaqueous electrolyte solution. Accordingly, the nonaqueous electrolyte solution may be reduction-electrolyzed, amplifying the capacity decrease due to charge/discharge cycles of the battery.

In order to restrain the capacity decrease accompanied by the discharge/discharge cycles of the alloy-type lithium secondary battery, the application of methods used for restraining the capacity decrease of lithium ion batteries has been attempted, such as those methods mentioned below. For example, it has been suggested to use a nonaqueous electrolyte solution for an alloy-type lithium secondary batteries, the nonaqueous electrolyte solution including a nonaqueous solvent containing cyclic and linear carbonates as basic components, wherein ethylene carbonate and vinylene carbonate are used as the cyclic carbonates, and diethyl carbonate is used as the linear carbonate (see, for example, the pamphlet of WO 02/058182). However, even with this method, an equivalent level of capacity restraining effect to that achieved in lithium ion batteries cannot be obtained.

Further, it has also been suggested to use a nonaqueous solvent included in an electrolyte in an alloy-type lithium secondary battery, the nonaqueous solvent containing, in combination, a cyclic carbonate such as ethylene carbonate and fluoroethylene carbonate, and a linear carbonate such as dimethyl carbonate and diethyl carbonate (see, for example, JP-A No. 2004-047131). In Sample 3 of the Examples therein is described a nonaqueous electrolyte solution containing ethylene carbonate, fluoroethylene carbonate, dimethyl carbonate and LiPF₆ at a ratio (by volume) of 20:10:58.5:11.5. However, in JP-A No. 2004-047131, only a material having a composition of 80 weight % of Cu and 20 weight % of Si is disclosed as a negative electrode active material used in combination with the nonaqueous electrolyte solution of Sample 3, and there is no description regarding the effects obtained when the nonaqueous electrolyte solution of Sample 3 is used in combination with any other negative electrode active materials.

Not only in alloy-type batteries but also in lithium secondary batteries, configuration is made so that there are reduced hollow walls in the battery, and gas is generated due to decomposition of the electrolyte solution in the battery by reaction with the positive and negative electrodes. In view of the above, it has been attempted to restrain gas generation via the composition of the solvent used, the electrolyte solution salt used, and the like (for example, JP-A No. 2005-32701). However, no attempt to restrain gas generation has been made for cases where a negative electrode of an alloy-type negative electrode is used. Moreover, there have been descriptions regarding a combination of difluoroethylene carbonate with a fluorinated linear carbonate, relating to a high voltage system of 4.3 V or more (for example, JP-A No. 2003-168480). However, the above document does not contain, in the sections “Means for solving the problems” and “Examples”, specific illustrations of the fluorinated linear carbonate or descriptions regarding improvement in the charge/discharge cycle characteristic of a lithium ion battery.

Patent Document 1: JP-A No. 62-290072

Patent Document 2: Japanese Patent Application National Publication (Laid-Open) No. 2001-501355

Patent Document 3: Pamphlet of WO 02/058182

Patent Document 4: JP-A No. 2004-047131

Patent Document 5: JP-A No. 2005-32701

Patent Document 6: JP-A No. 2003-168480

Non-Patent Document 1: Solid State Ionics, 113-115, p. 57 (1998)

### DISCLOSURE OF THE INVENTION

### Problems to be Solved by the Invention

An object of the invention is to give a nonaqueous electrolyte solution suitable for a lithium secondary battery having a high energy density, the capacity decrease thereof due to the charge/discharge cycles being remarkably suppressed, and further gas generation being prevented at the time of charging or storing; and a lithium secondary battery using the same.

### Means for Solving the Problems

In light of the above-mentioned problems, the inventors have made eager investigations and, as a result, arrived at the present invention. Accordingly, the nonaqueous electrolyte solution of the invention relates to:

1. A nonaqueous electrolyte solution comprising a nonaqueous solvent, the nonaqueous solvent comprising a fluorinated solvent including a linear fluorinated carbonate (a1) and a fluorinated ethylene carbonate (a2), wherein the total amount of the fluorinated solvent in the nonaqueous solvent is in the range of from 50 to 100 weight %.
2. The nonaqueous electrolyte solution of 1, wherein the total amount of the fluorinated ethylene carbonate (a2) in the nonaqueous solvent is from 0.5 to 50 weight %.
3. The nonaqueous electrolyte solution of 1 or 2, wherein the fluorinated ethylene carbonate (a2) is 4-fluoroethylene carbonate.
4. The nonaqueous electrolyte solution of any one of 1 to 3, wherein the linear fluorinated carbonate (a1) has fluorine atom(s) only at the end(s) of the chain thereof.
5. The nonaqueous electrolyte solution of 4, wherein the linear fluorinated carbonate (a1) has fluorine atom(s) only at a single end of the chain thereof.
6. A lithium secondary battery comprising: the nonaqueous electrolyte solution of any one of 1 to 5; a positive electrode comprising a positive electrode active material that is capable of reversible electrochemical reaction with lithium ions; and a negative electrode comprising a negative electrode active material that is capable of charging and removing the charge from lithium ions.
7. The lithium secondary battery of 6, wherein the negative electrode active material is at least one of Al, Si, Sn, Sb or Ge.

### EFFECTS OF THE INVENTION

The electrolyte solution of the invention can improve the charge/discharge cycle characteristic of a Li ion battery, and can restrain swelling of the battery when the battery is charged or stored. Accordingly, the electrolyte solution of the invention can achieve both of the charge/discharge cycle characteristics and the restrained generation of a gas when the battery is charged or stored, thereby corresponding to the increase in the capacity of batteries.

### BRIEF DESCRIPTION OF THE DRAWING

FIG. 1 is a chart showing relationships between the cycle capacity maintenance ratios and the swelling of the batteries after being stored at high temperature of Examples and Comparative examples.

### BEST MODE FOR CARRYING OUT THE INVENTION

The nonaqueous electrolyte solution of the invention and the lithium secondary battery using the same will be described hereinafter. The nonaqueous electrolyte solution of the invention contains a nonaqueous solvent including a linear fluorinated carbonate (a1) and a fluorinated ethylene carbonate (a2), both of which are essential components (hereinafter, referred to as a fluorinated solvent).

[Linear Fluorinated Carbonate (a1)]

The linear fluorinated carbonate (a1), which is one of the nonaqueous solvent concerned with the invention, has a linear structure having a carbonate group (—OCOO—) in which hydrogen atoms are partially or wholly substituted by fluorine atom(s). When this linear fluorinated carbonate (a1) is used as a nonaqueous solvent, the nonaqueous electrolyte solution does not readily react with the electrodes to decompose, and a nonaqueous electrolyte solution having a high degree of stability can be obtained. Examples of the linear fluorinated carbonate (a1) may include various types of carbonates, and may be a carbonate having the following structural formula:

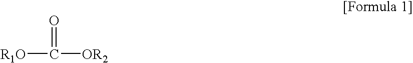

In the formula, R₁ and R₂ each represent an alkyl group, and at least one of these is an alkyl group having hydrogen atoms being partially or wholly substituted by fluorine atom(s).

Examples of such a linear fluorinated carbonate include methyl-2,2,2-trifluoroethyl carbonate, ethyl-2,2,2-trifluoroethyl carbonate, methyl-2,2,3,3,3-pentafluoropropyl carbonate, methyl-3,3,3-trifluoropropyl carbonate, methyl-2,2,3,3,4,4,4-heptafluorobutyl carbonate, 2,2,2-trifluoroethyl-2,2,3,3,3-pentafluoropropyl carbonate, fluoromethyl methyl carbonate, (difluoromethyl)methyl carbonate, bis(fluoromethyl) carbonate, (1-fluoroethyl)methyl carbonate, (2-fluoroethyl)methyl carbonate, ethyl fluoromethyl carbonate, (1-fluoroethyl)fluoromethyl carbonate, (2-fluoroethyl)fluoromethyl carbonate, (1,2-difluoroethyl)methyl carbonate, (1,1-difluoroethyl)methyl carbonate, (1-fluoroethyl)ethyl carbonate, (2-fluoroethyl)ethyl carbonate, ethyl(1,1-difluoroethyl) carbonate, ethyl(1,2-difluoroethyl) carbonate, bis(1-fluoroethyl) carbonate, bis(2-fluoroethyl) carbonate, and (1-fluoroethyl)(2-fluoroethyl) carbonate. Out of these, preferred are the carbonates having only the distol end(s) of the chain substituted by fluorine atom(s), and more preferred are the carbonates having a single distol end of the chain substituted with a fluorine atom. Particularly desired are methyl-2,2,2-trifluoroethyl carbonate and ethyl-2,2,2-trifluoroethyl carbonate, since they do not readily react with the electrodes to decompose, and exhibit a high degree of stability. A single kind of the linear fluorinated carbonate (al) may be used alone, or two or more kinds thereof may be used in combination.

[Fluorinated Ethylene Carbonate (a2)]

The fluorinated ethylene carbonate (a2) according to the invention is a compound having hydrogen atom(s) directly bonded to a carbonate ring thereof substituted by fluorine atom(s). When the fluorinated ethylene carbonate (a2) is used as a nonaqueous solvent, the carbonate readily reacts with the electrodes to form a coating film, thereby reducing the amount of the gas generated due to the reaction of the electrolyte solution. As this fluorinated ethylene carbonate (a2), various known carbonates may be used. Examples thereof include fluorinated ethylene carbonates having 1 to 4 hydrogen atom(s) in ethylene carbonate substituted by fluorine atom(s), such as 4-fluoroethylene carbonate, 4,4-difluoroethylene carbonate, 4,5-difluoroethylene carbonate, 4,4,5-trifluoroethylene carbonate, and 4,4,5,5-tetrafluoroethylene carbonate. Out of these, 4-fluoroethylene carbonate, having only one of the hydrogen atoms bonded directly to the carbonate ring of ethylene carbonate substituted by a fluorine atom, is most desired for the following reasons: the viscosity of the carbonate does not readily increase and the coordination force for lithium does not readily decrease, thereby suppressing the decrease in ion conductivity; the amount of LiF in the coating film of a negative electrode may be maintained to a moderate level, thereby suppressing the decrease in cycle properties; and the reaction level with the negative electrode is low, thereby suppressing generation of a gas, as compared with the other fluorinated ethylene carbonates (a2). A single kind of the fluorinated ethylene carbonates (a2) may be used alone, or two or more kinds thereof may be used in combination.

[Nonaqueous Solvent]

The nonaqueous solvent according to the invention includes, as an essential component, a fluorinated solvent containing a linear fluorinated carbonate (a1) and a fluorinated ethylene carbonate (a2). The content of the fluorinated solvent in the nonaqueous solvent may be appropriately selected, and the nonaqueous solvent is most preferably composed of only the linear fluorinated carbonate (a1) and the fluorinated ethylene carbonate (a2). However, the nonaqueous solvent may contain a nonaqueous solvent other than the above, as long as the object of the invention is not impaired.

The content of the fluorinated solvent in the nonaqueous solvent according to the invention may be appropriately selected in accordance with the purposes, and is usually from 50 to 100 weight %, preferably from 70 to 100 weight %, even more preferably from 80 to 100 weight %, and particularly preferably from 90 to 100 weight %. When the content is within the above range, the charge/discharge cycle characteristic can be favorably improved, and the gas generation when charging/discharging or storing can be favorably restrained, when the nonaqueous solvent is used as a nonaqueous electrolyte solution of a secondary battery.

The content of the fluorinated ethylene carbonate (a2) in the nonaqueous solvent according to the invention is preferably from 0.5 to 50 weight %, more preferably from 0.5 to 30 weight %, particularly preferably from 0.5 to 20 weight %, and most preferably from 5 to 20 weight %. When the content of the fluorinated ethylene carbonate (a2) is within the above range, the reactivity of the nonaqueous electrolyte solution due to the fluorinated ethylene carbonate (a2) can be restrained, while the stability with the electrodes due to the linear fluorinated carbonate (a1) can be achieved, and therefore a preferred nonaqueous electrolyte solution can be obtained.

[Non-Fluorinated Solvent]

The nonaqueous solvent according to the invention may contain a nonaqueous solvent that is different from the above-mentioned fluorinated solvent, and examples thereof usually include a non-fluorinated carbonate. The non-fluorinated carbonate may be selected from various ones in accordance with the purpose thereof, and may contain one or more kinds thereof. The nonaqueous solvent according to the invention may contain the nonaqueous solvent other than the linear fluorinated carbonate (a1) and the fluorinated ethylene carbonate (a2) at an amount of 90 weight % or less, preferably less than 50 weight %, more preferably 30 weight % or less, particularly preferably 20 weight % or less, and still more preferably 10 weight % or less, with respect to the nonaqueous solvent.

The nonaqueous solvent different from the above-mentioned fluorinated solvent may be, for example, a carbonate having a cyclic structure or a carbonate having a linear structure. Specific examples thereof include ethylene carbonate, propylene carbonate, butylene carbonate, 1,2-pentene carbonate, 1,2-hexene carbonate, 1,2-heptene carbonate, 1,2-octene carbonate, 1,2-nonene carbonate, 1,2-decene carbonate, 1,2-dodecene carbonate, 5,6-dodecene carbonate, dimethyl carbonate, diethyl carbonate, dipropyl carbonate, dibutyl carbonate, dipentyl carbonate, dihexyl carbonate, dioctyl carbonate, methyl ethyl carbonate, methyl propyl carbonate, methyl butyl carbonate, methyl pentyl carbonate, methyl hexyl carbonate, methyl octyl carbonate, ethyl propyl carbonate, ethyl butyl carbonate, ethyl pentyl carbonate, ethyl hexyl carbonate, ethyl octyl carbonate, vinylene carbonate, methylvinylene carbonate, dimethylvinylene carbonate, phenylvinylene carbonate, diphenylvinylene carbonate, ethylvinylene carbonate, diethylvinylene carbonate, vinylethylene carbonate, 1,2-divinylethylene carbonate, 1-methyl-1-vinylethylene carbonate, 1-methyl-2-vinylethylene carbonate, 1-ethyl-1-vinylethylene carbonate, 1-ethyl-2-vinylethylene carbonate, vinylvinylene carbonate, allylethylene carbonate, vinyloxymethylethylene carbonate, allyloxymethylethylene carbonate, acryloxymethylethylene carbonate, methacryloxymethylethylene carbonate, ethynylethylene carbonate, propargylethylene carbonate, ethynyloxymethylethylene carbonate, propargyloxyethylene carbonate, methyleneethylene carbonate, and 1,1-dimethyl-2-methyleneethylene carbonate. The nonaqueous solvent according to the invention may contain two or more of the above-mentioned compounds.

[Nonaqueous Electrolyte Solution]

The nonaqueous electrolyte solution of the invention contains the above-mentioned nonaqueous solvent and contains compounds used as an ordinary nonaqueous electrolyte solution, such as an electrolyte. A lithium salt may be usually employed as the electrolyte, and those commonly used in this field are applicable. Examples thereof include LiPF₆, LiBF₄, LiClO₄, LiAsF₆, Li₂SiF₆, LiOSO₂CₖF₍₂ₖ₊₁₎ where k=an integer of 1 to 8, LiN(SO₂CₖF₍₂ₖ₊₁₎)₂ where k=an integer of 1 to 8, LiPFₙ(CₖF₍₂ₖ₊₁₎)₍₆₋ₙ₎ where n=1 to 5, and k=an integer of 1 to 8, and LiBFₙ(CₖF₍₂ₖ₊₁₎)₍₄₋ₙ₎ where n=1 to 3, and k=an integer of 1 to 8. Lithium salts represented by the following general formulae may also be used: LiC(SO₂R¹¹)(SO₂R¹²)(SO₂R¹³), LiN(SO₂₀R¹⁴)(SO₂OR¹⁶), LiN(SO₂R¹⁶)(SO₂₀R¹⁷), LiN(SO₂R¹⁶)(SO₂F), and LiN(SO₂F)₂ where R¹¹ to R¹⁷ each independently represent a perfluoroalkyl group having 1 to 8 carbon atoms that may be the same or different. Examples of a borate lithium salt or a phosphate lithium salt include lithium bis(oxalato)borate, lithium bis(oxalato)fluorophosphate, lithium bis(oxalato)fluorophosphate, and lithium trifluoro(oxalato)phosphate. The lithium salt may be used as a single species alone, or two or more species thereof in combination.

Out of the above-mentioned lithium salts, preferred are LiPF₆, LiBF₄, LiN(SO₂CF₃)₂ and LiN(SO₂C₂F₅)₂, and most desired is LiPF₆ from the viewpoint of ion conductivity of the nonaqueous electrolyte solution. Further, from the viewpoint of electrochemical stability of the nonaqueous electrolyte solution, it is desired to use LiPF₆ alone, or as a mixture of LiPF₆ and LiBF₄, LiPF₆ and LiN(SO₂CF₃)₂, or LiPF₆ and LiN(SO₂C₂F₅)₂.

The amount of the lithium salt contained in the nonaqueous electrolyte solution may be in a range usually employed in this field. The salt is dissolved in the nonaqueous electrolyte solution at a concentration of 1 to 50 weight % (1 weight % or more and 50 weight % or less), preferably 4 to 30 weight % (4 weight % or more and 30 weight % or less).

In the nonaqueous electrolyte solution of the invention, various additives may be used other than the aforementioned nonaqueous solvent and the electrolyte, as long as the object of the invention is not impaired. The additives may be selected for use from various known additives, and examples thereof include a fluorinated linear ether, a fluorinated cyclic ether, phosphates, ethers, carbamates, amides, sulfones, sulfonic acid esters, carboxylic acid esters, and aromatic compounds. However, when the nonaqueous electrolyte solution is used in an alloy-type lithium secondary battery, as is the case with the invention, these additives may cause a fall in the charge/discharge cycle characteristic. Therefore, when one or more of these nonaqueous solvents are incorporated in accordance with some purpose, the content thereof is desirably as small as possible.

[Negative Electrode]

The negative electrode of the lithium secondary battery according to the invention includes a negative electrode current collector and a negative electrode active material layer. The negative electrode may be selected from various known ones. A specific example thereof may be an electrode in which a negative electrode active material layer is formed on the surface or inside of a negative electrode current collector.

The negative electrode current collector may be one used usually in this field. In particular, preferred is a negative electrode current collector having an excellent adhesion to a thin film of the negative electrode active material layer. Examples thereof include copper, nickel, titanium, iron, stainless steel, molybdenum, cobalt, chromium, tungsten, tantalum, and silver. Out of these, more preferred are metals which do not form an alloy with lithium, such as copper. The negative electrode current collector is preferably used in the form of a metallic foil, an expanded metal, or the like.

The negative electrode active material layer may be, for example, a sheet or film containing negative electrode active material particles and a conductant agent or the like formed using a binder such as polyvinylidene fluoride; a sheet or film formed by embedding negative electrode active material particles into a metal sheet; and a thin film of the negative electrode active material by itself. The negative electrode active material particles may be particles obtained by embedding a negative electrode active material into metal particles or carbon particles, or by allowing the negative electrode active material to be carried onto the surface of metal particles or carbon particles, and then forming the particles. As mentioned above, the negative electrode active material layer may be formed into any optional shape, however, it is preferred to be a thin film from the viewpoint of improving the charge/discharge cycle characteristic and other various battery performances.

The negative electrode active material layer may be a commonly used carbon based negative electrode, but desirably contains a negative electrode active material containing at least one selected from: (b1) an element capable of forming a compound or a solid solution with lithium; (b2) an alloy containing the element (b1); and (b3) a compound containing the element (b1). By including those, further growth in energy density of batteries may be expected. These negative electrode active materials (b1) to (b3) can remarkably increase the adsorption amount of lithium per unit volume, as compared with the conventionally employed carbon materials, thereby largely reducing the volume occupied by the negative electrode in the battery and thus enhancing the energy density of the battery.

Specific examples of the element (b1) capable of forming a compound or a solid solution with lithium to be contained in the negative electrode active material include: elements in the group 12 in the periodic table, such as Zn, Cd or Hg; elements in the group 13 in the periodic table, such as Al, Ga, In and Tl; elements in the group 14 in the periodic table, such as Si, Ge, Sn and Pd; and elements in the group 15 in the periodic table, such as As, Sb and Bi. The negative electrode active material may be in the form of an alloy (b2) or a compound (b3) containing these elements. The compound (b3) containing the element (b1) may be an oxide, a sulfide or the like. Out of these, preferred is a simple substance of the element (b1) capable of forming a compound or a solid solution with lithium, in view of lithium adsorbing property, environment adaptability, low electric power consumption at the time of initial charging of the battery, and the like. The compound (b3) containing the element (b1) may fail to enhance the energy density of the lithium battery, since the compound (b3) usually consumes a large quantity of irreversible reduction current when the battery is initially charged. The alloy (b2) containing the element (b1) may fail to enhance the energy density of the lithium battery, since the alloy (b2) contains other alloy component(s) than the element (b1) that does not contribute to storing of lithium.

The element (b1) is preferably an element in the groups 13 to 15 in the periodic table, and more preferably an element in the groups 13 to 14 in the periodic table. Specifically, the element is more preferably at least one selected from Al, Si, Sn, Sb or Ge, and particularly preferably Al and Si. Si is classified roughly into amorphous silicon, microcrystalline silicon, polycrystalline silicon, and monocrystalline silicon, in accordance with the difference in crystallinity. These categories are also clearly distinguished from each other in terms of instrumental analysis. For example, according to the Raman analysis, a peak at around 520 cm⁻¹, which corresponds to a crystalline region, of amorphous silicon is not substantially detected, while a peak at around 520 cm⁻¹, which corresponds to a crystalline region, and a peak at around 480 cm⁻¹ which corresponds to an amorphous region, of microcrystalline silicon are substantially detected. On the other hand, polycrystalline silicon and monocrystalline silicon do not substantially have a peak at around 480 cm⁻¹, which corresponds to an amorphous region, and therefore are materials having different crystal structures from those of amorphous silicon and microcrystalline silicon. Out of these silicons having various crystalline structures, amorphous silicon and microcrystalline silicon are preferred.

The negative electrode active material containing at least one of (b1) an element capable of forming a compound or a solid solution with lithium, (b2) an alloy of the element (b1), or (b3) a compound containing the element (b1), may be used alone or two or more thereof in combination.

The surface of the negative electrode active material may be covered with a lithium ion-conductive solid electrolyte, a carbon material, a metal or the like. The negative electrode active material may also be in a composite form, for example, a form in which the negative electrode active material is dispersed in a lithium-ion-conductive solid electrolyte, a carbon material, a metal or the like.

In the negative electrode according to the invention, a metal that does not form an alloy with lithium may also be used together with the negative electrode active material, in order to further enhance the charge/discharge cycle characteristic of the battery. In other words, by incorporating the negative electrode active material and a metal that doe not form an alloy with lithium into the negative electrode active material layer, expansion and shrinkage of the negative electrode active material layer when charging/discharging may be restrained, thereby improving the charge/discharge performance of the battery. Such a structure is described in JP-A No. 2002-373647. However, when a metal that does not form an alloy with lithium, and thus does not contribute to the charge/discharge, is incorporated, the energy density of the battery may be lowered. Accordingly, the negative electrode active material desirably exists in the form of an element. The wording “form of an element” refers to a state that a simple substance of the element is contained in the negative electrode active material at an amount of 90 weight % or more, and may include, for example, a state in which an impurity element is doped into the material to improve strength, stability and the like.

The thickness of the thin film that corresponds to the negative electrode active material layer formed on the surface of the negative electrode current collector is not particularly limited, and may be appropriately selected from a broad range in accordance with the set performances of the battery to be achieved. The thickness may be, for example, from about 1 to 20 μm (1 μm or more and 20 μm or less), considering, for example, the charge/discharge capacity and the like.

Furthermore, a mixed layer of a current collector component and a negative electrode active material layer component may be formed at the interface between the negative electrode current collector and the negative electrode active material layer. In this way also, the adhesion of the negative electrode active material layer to the current collector may be strengthened, and further improvement in the cycle characteristic may be expected. Such a mixed layer may be formed by forming the negative electrode active material layer on the current collector, and then carrying out a thermal treatment or the like. The temperature for the thermal treatment is preferably lower than the melting points of the negative electrode active material layer and the current collector. The material for the intermediate layer may be selected appropriately from materials that can form an alloy, or preferably a solid solution, with the material of the negative electrode active material and/or the current collector material.

[Positive Electrode]

The positive electrode of the lithium secondary battery according to the invention includes a positive electrode active material layer and a positive electrode current collector.

As the positive electrode active material, a material into which lithium may be electrochemically inserted, and from which lithium may be electrochemically released, may be used without particularly limited. The material may be, for example, a lithium-containing transition metal oxide such as LiCoO₂, LiNiO₂, LiMn₂O₄, LiMnO₂, LiNiₓCo₍₁₋ₓ₎O₂ where x is any number of 0 or more and 1 or less that may be a decimal number, or LiNiₓCo_{y}Mn_{(1-x-y)}O₂ where x and y are each independently any number of 0 or more and 1 or less that may be a decimal number, but (x+y) should be 1 or less; a lithium-free metal oxide, such as MnO₂; or the like. The positive electrode active material may be used alone, or two or more species thereof in combination.

As the positive electrode current collector, known materials may be used. An example thereof is a metal such as Al, Ti, Zr, Hf, Nb or Ta, or an alloy containing these elements, onto which a passive film is formed by performing anode oxidization in the nonaqueous electrolyte solution.

The positive electrode according to the invention may be prepared by the methods, for example, (A) forming a composition containing the positive electrode active material and a binder into a desired shape, bonding the formed product to the positive electrode current collector, and optionally pressing the resultant; (B) adding a solvent further to the composition containing the positive electrode active material and the binder to prepare a slurry of positive electrode mixture, applying this slurry onto one side of the positive electrode current collector and drying, and optionally pressing the resultant; or (C) forming the positive electrode active material into a desired shape by roll molding, compression molding, or the like. In the method (A), the binder may be one usually employed in this field. Examples thereof include fluorine-contained resins, such as polyvinylidene fluoride and polytetrafluoroethylene, celluloses such as carboxymethylcellulose and cellulose, and latexes such as styrene/butadiene rubber, isoprene rubber, butadiene rubber, ethylene/propylene rubber and natural rubber. In the method (B), the same binder as indicated in the method (A) may be used. The solvent may be one usually employed in this field, and examples thereof include N-methylpyrrolidone, dimethylacetoamide, dimethylformamide, propylene carbonate, γ-butyrolactone, and N-methyloxazolidinone. The solvent may be used alone or two or more species thereof in combination.

The electric potential of the positive electrode in the prior art is 4.2 V on the basis of lithium electric potential. In order to attain a higher energy density, it is desired to use the positive electrode in such a manner that the electric potential of the positive electrode is 4.3 V or more on the basis of lithium electric potential, when the battery is fully charged.

[Separator]

The separator of the lithium secondary battery according to the invention is a membrane that electrically insulates the positive electrode from the negative electrode, and allows lithium ions to permeate therethrough. A porous film, a nonwoven cloth film, a polymeric electrolyte material and the like may be used for the separator. As the porous film, preferred is a microporous polymeric film, and the material thereof may be polyolefin, polyimide, polyvinylidene fluoride, polyester or the like. A porous polyolefin film is particularly preferred, and specific examples thereof include a porous polyethylene film, a porous polypropylene film, and a multilayered film composed of a porous polyethylene film and polypropylene. The porous polyolefin film may be covered with another resin having excellent thermal stability. Examples of the polymeric electrolyte include a polymer in which a lithium salt is dissolved, and a polymer swelled with a nonaqueous electrolyte solution.

[Lithium Secondary Battery]

The lithium secondary battery of the invention is constructed including the above-mentioned nonaqueous electrolyte solution of the invention. The lithium secondary battery of the invention may be made into various known structures. The lithium secondary battery is generally composed of the above-mentioned nonaqueous electrolyte solution, negative electrode, positive electrode and separator. Having such a structure, the charge/discharge cycle characteristic of the lithium secondary battery of the invention can be improved, and swelling thereof due to generation of a gas when charging/discharging or storing the battery can be restrained. Accordingly, the lithium secondary battery of the invention is adaptable to increase in capacity. In particular, when the above-mentioned negative electrode is used, generation of a gas can be restrained due to the reduced reaction at the interface between the nonaqueous electrolyte solution and the negative electrode, and thus a particularly preferred battery can be obtained.

The lithium secondary battery of the invention may be made into any shapes, such as a cylindrical form, coin form, rectangular form, or film form. However, the basic structure of the battery is the same irrespective of the shape of the battery, and a design change may be applied thereto in accordance with purposes. For example, when the lithium secondary battery of the invention is in a cylindrical form, the battery has such a structure that a roll is contained in a battery can together with a pair of insulator plates put on and under the roll, the roll being composed of a sheet-form negative electrode and a sheet-form positive electrode that are rolled up interleaving a separator, and impregnated with the above-mentioned nonaqueous electrolyte solution. When the battery is in a coin form, the battery has such a structure that a laminate composed of a disc-like negative electrode, a separator and a disc-like positive electrode is impregnated with the nonaqueous electrolyte solution, and contained into a coin-shaped battery can, optionally with a spacer plate inserted therein.

The lithium secondary battery of the invention may be used in the same applications as conventional lithium secondary batteries. For example, the battery may be favorably used as a power source for various consumer-use electric instruments such as, in particular, a cellular phone, a mobile device, a laptop personal computer, a camera, a portable video recorder, a portable CD player, a portable MD player and the like.

### EXAMPLES

Hereinafter, the present invention will be specifically described by referring to examples and comparative examples. However, the invention is not limited to the examples.

<Preparation of Nonaqueous Electrolyte Solutions>

The following were mixed at composition percentages as described in Table 1 (weight %) to prepare the mixed solvents: ethylene carbonate (abbreviated to EC: a cyclic carbonate consisting only of hydrogen, oxygen and carbon); diethyl carbonate (abbreviated to DEC: a linear carbonate consisting only of hydrogen, oxygen and carbon); vinylene carbonate (abbreviated to VC: a carbonate consisting only of hydrogen, oxygen and carbon, and having a carbon-carbon unsaturated bond); 4-fluoroethylene carbonate (abbreviated to FEC: a fluorinated ethylene carbonate); trifluoromethylethylene carbonate (abbreviated to TFPC: a fluorinated cyclic carbonate); methyl-2,2,2-trifluoroethyl carbonate (abbreviated to MFEC: a fluorinated linear carbonate); and ethyl-2,2,2-trifluoroethyl carbonate (abbreviated to EFEC: a fluorinated linear carbonate). Thereafter, the mixed solvents were mixed with LiPF₆ (a lithium salt) or LiN(SO₂CF₂CF₃)₂ (abbreviated to LiBeti: a lithium salt) to adjust the concentration of the lithium salt in the electrolyte solution to 1 mol/L. Each of the blank spaces shows that the compound corresponding to the space was not contained.

TABLE 1

| | | | | | Fluorinated solvents | | | | | |
|---|---|---|---|---|---|---|---|---|---|---|
| | Non-fluorinated carbonates | | | | Fluorinated | Linear | | | | |
| Nonaqueous | | | | Total of the | ethylene | fluorinated | | | Total of | |
| electrolyte | | | | non-fluorinated | carbonate | carbonates | | | fluorinated | |
| solution | EC | DEC | VC | carbonates | FEC | MFEC | EFEC | TFPC | solvent | Electrolytic salt |
| 1 | | | | 0 | 50 | 50 | | | 100 | LiPF₆ |
| 2 | | | | 0 | 30 | 70 | | | 100 | LiPF₆ |
| 3 | | | | 0 | 20 | 80 | | | 100 | LiPF₆ |
| 4 | | | | 0 | 10 | 90 | | | 100 | LiPF₆ |
| 5 | | | | 0 | 5 | 95 | | | 100 | LiPF₆ |
| 6 | | | | 0 | 1 | 99 | | | 100 | LiPF₆ |
| 7 | | | | 0 | 0.3 | 99.7 | | | 100 | LiPF₆ |
| 8 | 5 | | | 5 | 10 | 85 | | | 95 | LiPF₆ |
| 9 | | 5 | | 5 | 10 | 85 | | | 95 | LiPF₆ |
| 10 | 5 | 5 | | 10 | 10 | 80 | | | 90 | LiPF₆ |
| 11 | 10 | 10 | | 20 | 10 | 70 | | | 80 | LiPF₆ |
| 12 | 15 | 15 | | 30 | 10 | 60 | | | 70 | LiPF₆ |
| 13 | | | | 0 | 10 | | 90 | | 100 | LiPF₆ |
| 14 | | | 0.2 | 0.2 | 10 | 89.8 | | | 99.8 | LiPF₆ |
| 15 | | | | 0 | 10 | | 90 | | 100 | LiBeti |
| 16 | 50 | 50 | | 100 | | | | | 0 | LiPF₆ |
| 17 | 49 | 49 | 2 | 100 | | | | | 0 | LiPF₆ |
| 18 | 43.5 | 43.5 | 3 | 90 | 10 | | | | 10 | LiPF₆ |
| 19 | | | | 0 | | 90 | | 10 | 100 | LiPF₆ |
| 20 | 35 | 35 | | 70 | | 30 | | | 30 | LiPF₆ |

Unit: % by weight

### Example 1

A cycle test and a battery swelling test as described below were conducted using the nonaqueous electrolyte solution No. 1 shown in Table 1. The results are shown in Table 2.

1. Cycle Test

A coin-shaped battery was prepared in accordance with a process described below, and then the discharge capacity at the first cycle and the discharge capacity maintenance ratio (%) at the 20th cycle were measured.

(1) Formation of an Al Negative Electrode

An aluminum foil of 20 μm in thickness was punched out into a coin shape of 14 mm in diameter, and vacuum-dried at 100° C. for 2 hours to obtain a coin-shaped negative electrode. In this coin-shaped negative electrode, an aluminum element serves as the negative electrode active material. When this negative electrode was charged/discharged at 1.5 to 0 V, using metal lithium as a counter electrode, the charge/discharge capacity of the lithium was 7.5 mAh.

(2) Formation of a Positive Electrode

82 parts of LiCoO₂ (trade name: HLC-22, manufactured by Honjo FMC Energy Systems Inc.), 7 parts of graphite (a conductive agent), 3 parts of acetylene black (a conductive agent), and 8 parts of polyvinylidene fluoride (a binder) were mixed, and the mixture was dispersed into 80 parts of N-methylpyrrolidone to prepare a LiCoO₂ mixture slurry. This LiCoO₂ mixture slurry was applied onto an aluminum foil of 20 μm in thickness, and dried and roll-pressed. The resultant was punched out into a disc of 13 μm in diameter, and thus a coin-shaped positive electrode was prepared. When this positive electrode was charged/discharged at 3.0 to 4.3 V, using metal lithium as a counter electrode, the charge/discharge capacity of the lithium was 4.5 mAh.

(3) Formation of a Coin-Shaped Battery

The coin-shaped negative electrode and the coin-shaped positive electrode obtained as described above, and a separator made of a microporous polypropylene film of 25 μm in thickness and 16 mm in diameter were laminated in the order of the negative electrode, the separator and the positive electrode, and were put in a negative electrode can of a 2032-size battery can made of stainless steel. Thereafter, 30 μL of the nonaqueous electrolyte solution was infused into the separator. A plate made of aluminum and a spring were then put onto the laminate. Lastly, the resultant was covered with a battery positive electrode can with a gasket made of polypropylene interposed therebetween, and a can lid was caulked to keep the inside of the battery airtight. A coin-shaped battery of 20 mm in diameter and 3.2 mm in height was thus obtained. The initial charge/discharge (charging and discharging) as described below was performed using this coin-shaped battery. Five cycles of the charge/discharge (one cycle is a pair of charging and discharging) were repeated to prepare a test battery.

(Initial Charge/Discharge)

Charge: The battery was charged up to 4.1 V at a constant current of 0.5 mA, and thereafter the battery was charged at a constant voltage of 4.1 V until the current became 0.1 mA. The electric potential of the positive electrode at this time was 4.35 V in terms of the Li electric potential.

Discharge: The battery was discharged down to 2.8 V at a constant current of 0.5 mA, and thereafter the battery was discharged at a constant voltage of 2.8 V until the current became 0.1 mA.

(4) Conditions for the Charge/Discharge Cycle Test

A charge/discharge cycle test was conducted using the test battery prepared as described above. In the charge/discharge cycle test, 30 cycles of the ordinary cycle described below (one cycle refers to a pair of charge and discharge) were repeated.

(Ordinary Cycle)

Charge: The battery was charged up to the set value of 4.1 V at a constant current of 2.5 mA, and thereafter the battery was continuously charged at 4.1 V until the current became 0.1 mA.

Discharge: The battery was discharged down to the set value of 2.8 V at a constant current of 2.5 mA.

The discharge capacity after the first cycle and the discharge capacity after the 20th cycle were measured, and then the cycle capacity maintenance ratio (%) was calculated in accordance with the formula described below. The result is shown in Table 2.

Cycle capacity maintenance ratio (%)=(discharge capacity at the 20th cycle)/(discharge capacity at the 1st cycle)×100 (%)

2. High-Temperature Charging/Storing Test

In order to measure the amount of a gas generated by decomposition of the electrolyte solution when charging and storing the battery at high temperature (high-temperature charging/storing), a laminate battery was formed according to a process described below. The swelling of the battery after charging the battery at room temperature, and the swelling of the battery after charging and storing the battery at high temperature were measured.

(1) Formation of an Al Negative Electrode

An aluminum foil of 20 μm in thickness was cut into a size of 3 cm×4 cm. A lead made of nickel was attached to an end of the foil to form a negative electrode. The charge/discharge capacity of lithium at the time of charging and discharging this negative electrode at 1.5 to 0 V, using metal lithium as a counter electrode, was 58 mAh.

(2) Formation of a Positive Electrode

82 parts of LiCoO₂ (trade name: HLC-22, manufactured by Honjo FMC Energy Systems Inc.), 7 parts of graphite (a conductive agent), 3 parts of acetylene black (a conductive agent), and 8 parts of polyvinylidene fluoride (a binder) were mixed, and dispersed into 80 parts of N-methylpyrrolidone to prepare a LiCoO₂ mixture slurry. This LiCoO₂ mixture slurry was applied onto an aluminum foil pf 20 μm in thickness, and dried and roll-pressed. This electrode was punched out into a size of 2.5 cm×4 cm, and a lead made of aluminum was attached to an end thereof to form a positive electrode. The charge/discharge capacity at the time of charging and discharging this positive electrode at 3.0 to 4.3 V, using metal lithium as a counter electrode, was 34 mAh.

(3) Formation of a Laminate Battery

The above-mentioned negative electrode and positive electrode were placed to face each other via a separator made of a microporous polypropylene film of 40 mm in width and 60 mm in length, thereby preparing an electrode pair. This electrode pair was put into a tubular bag made of an aluminum laminate film in such a manner that each lead of the negative and positive electrodes were pulled out from one of the openings of the tubular bag. The opening from which the leads were pulled out was closed by heat-melting. In this state, the resultant was vacuum-dried, and subsequently, 0.4 mL of an electrolyte solution was infused to impregnate the electrode pair with the electrolyte solution. Thereafter, the other opening was air-tightly closed by heat-melting, thereby obtaining a laminate battery.

When a gas is generated by redox decomposition of the electrolyte solution in the laminate battery, the whole body of the laminate battery swells in a substantially uniform manner, since the material of the casing of the battery is an aluminum laminate film.

(4) Battery Swelling Test

The “battery swelling after charging” and the “battery swelling after storing at high temperature” of the laminate battery obtained in the above were calculated in a manner as described below. The results are shown in Table 2.

(5) Battery Swelling after the Charging

The battery was charged up to 4.1V at a constant current of 1.4 mA, and thereafter the battery was continuously charged at 4.1 V until the current became 0.01 mA. In this way, a charged laminate battery was prepared. The electric potential of the positive electrode at this time was 4.35 V in terms of the Li electric potential. The volume of the freshly prepared uncharged laminate battery and the volume of the charged laminate battery were measured by the Archimedes' method. The difference between the above volumes was defined as the swelling after charging (mL).

(6) Battery Swelling after Storing at High-Temperature

The charged laminate battery obtained as above was put into a thermostatic chamber at 85° C., and the battery was allowed to stand for 3 days. The volume of the freshly prepared uncharged laminate battery and the volume of the laminated battery after being stored at high temperature were measured by the Archimedes' method. The difference between the above volumes was defined as the swelling after storing at high temperature (mL).

### Example 2

The cycle characteristic test and battery swelling test were conducted in the same way as in Example 1, except that the nonaqueous electrolyte solution was changed to the nonaqueous electrolyte solution No. 2 described in Table 1. The results are shown in Table 2.

### Examples 3 to 15 and Comparative Examples 1 to 5

In the same manner, batteries were prepared using the nonaqueous electrolyte solutions No. 3 to No. 20, and the cycle characteristic test and battery swelling test for Examples 3 to 15 and Comparative Examples 1 to 5 were conducted. The results are shown in Table 2.

TABLE 2

| | Nonaqueous | | | | Battery swelling |
|---|---|---|---|---|---|
| | electrolyte | Discharge capacity | Cycle capacity | Battery swelling | after storing at |
| | solution No. | at one cycle [mAh] | maintenance ratio [%] | after charging [ml] | high temperature [ml] |
| Example 1 | 1 | 3.4 | 60 | 0.03 | 0.41 |
| Example 2 | 2 | 3.3 | 55 | 0.02 | 0.32 |
| Example 3 | 3 | 3.3 | 50 | 0.02 | 0.15 |
| Example 4 | 4 | 3.4 | 45 | 0.01 | 0.09 |
| Example 5 | 5 | 3.3 | 40 | 0.01 | 0.07 |
| Example 6 | 6 | 3.5 | 30 | 0.02 | 0.05 |
| Example 7 | 7 | 3.4 | 20 | 0.02 | 0.04 |
| Example 8 | 8 | 3.5 | 40 | 0.03 | 0.05 |
| Example 9 | 9 | 3.3 | 40 | 0.03 | 0.12 |
| Example 10 | 0 | 3.4 | 35 | 0.02 | 0.17 |
| Example 11 | 11 | 3.4 | 30 | 0.03 | 0.27 |
| Example 12 | 12 | 3.3 | 25 | 0.03 | 0.40 |
| Example 13 | 13 | 3.5 | 45 | 0.01 | 0.07 |
| Example 14 | 14 | 3.3 | 47 | 0.02 | 0.08 |
| Example 15 | 15 | 3.4 | 45 | 0.03 | 0.32 |
| Comparative | 16 | 3.4 | 10 | 0.03 | 1.05 |
| example 1 | | | | | |
| Comparative | 17 | 3.5 | 15 | 0.03 | 1.35 |
| example 2 | | | | | |
| Comparative | 18 | 3.3 | 15 | 0.03 | 1.26 |
| example 3 | | | | | |
| Comparative | 19 | 3.5 | 5 | 0.03 | 0.25 |
| example 4 | | | | | |
| Comparative | 20 | 3.4 | 10 | 0.03 | 1.02 |
| example 5 | | | | | |

3. Cycle Characteristic Evaluation Results

As seen in Table 2, Examples 1 to 15 have better cycle characteristics than those of Comparative Examples 1 to 5. Thus, it is evident that in order to improve the cycle characteristic, a linear fluorinated carbonate and a fluorinated ethylene carbonate are essential. Further, from the comparison of Example 4 and Comparative Example 4, it is understood that Example 4 has a better cycle characteristic than that of Comparative Example 4, even though the fluorinated solvent contents in both cases are 100% by weight, indicating that the fluorinated ethylene carbonate is superior as a cyclic fluorinated carbonate. It is also found from the results of Examples 4 and 8 to 11 that the cycle characteristics are better when the content of the fluorinated solvent is in the range of from 80 to 100 weight %. Moreover, it is found from the results of Examples 1 to 6 that the cycle characteristics are better when the ratio of the fluorinated ethylene carbonate is in the range of from 0.5 to 50 weight %.

4. High-Temperature Charging/Storing Test (Battery Swelling Evaluation Results)

As seen in Table 2, the amount of swelling of the batteries after charging and the amount of the gas generated at the initial charging of the batteries in Examples 1 to 15 are smaller than those in Comparative examples 1 to 5. Further, it is found that when storing the batteries at high temperature, no swelling to a significant level is observed and the reaction with the electrodes and the like are suppressed in Examples 1 to 15, whereas the swelling of batteries in Comparative Examples 1 to 3 and 5 are large. Moreover, as seen from the results of Examples 4, and 8 to 12, the swelling amount of the batteries after charging and storing at high temperature is small when the total amount of the fluorinated solvent is in the range of from 80 to 100 weight %, and from the results of Examples 7 to 12 is found that the swelling amount of the batteries after charging and storing at high temperature is small when the content of the fluorinated ethylene carbonate is 40 weight % or less.

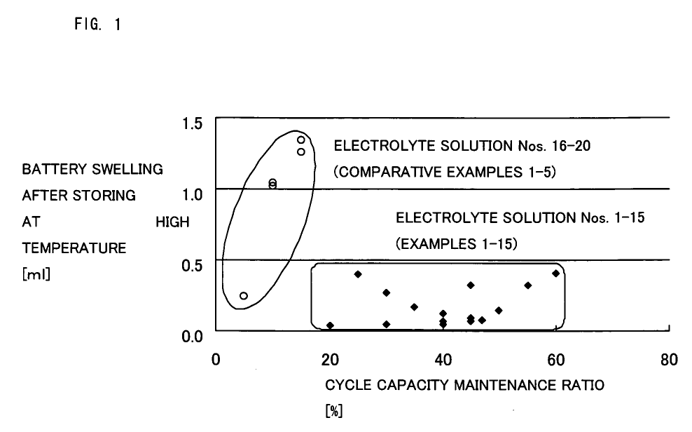

FIG. 1 shows a relationship between the cycle capacity maintenance ratio and the battery swelling when charging and storing the battery at high temperature, based on Table 2. It is understood that the nonaqueous electrolyte solutions of No. 1 to No. 15, the electrolyte solutions of the invention, have a high degree of cycle capacity maintenance ratio, and exhibit a small degree of battery swelling when charging and storing the battery at high temperature. It is also found that none of the nonaqueous electrolyte solutions No. 16 to No. 20, used in the comparative examples, satisfies both of the cycle capacity maintenance ratio and the restraint of generation of a gas at charging/storing at high temperature, at favorable levels. Among these, it is understood that the electrolyte solutions used in Examples 2 to 5, containing the fluorinated solvent at 100 weight % and the fluorinated ethylene carbonate at 5 to 30 weight %, achieve particularly favorable levels of both of the cycle capacity maintenance ratio and the restraint of the generation of a gas at charging/storing at high temperature.

### Examples 16 to 18 and Comparative Example 6

5. Si Electrode-Li Counter Electrode Battery Test

In order to determine the effects of other negative electrodes than the Al negative electrode, a battery having a Si electrode and a Li counter electrode of metallic Li was formed and a cycle characteristic test was conducted. The coin-shaped Si electrode-Li counter electrode battery was formed in accordance with a process described below.

(1) Formation of a Si Electrode

A thin film of Si, a negative electrode active material, was formed on a strip-shaped copper foil of 18 μm in thickness by RF sputtering. The sputtering was performed using a SPUTTERING SYSTEM HSM-521 (manufactured by Shimadzu Corporation). The conditions for the sputtering were as follows: sputtering gas: Ar, vacuum degree: 6.8×10⁻⁶ TORR, substrate temperature: room temperature, and high frequency power: 400 W. Under these conditions, Si was deposited to a thickness of 2 μm.

The negative electrode current collector with the above silicon thin film formed thereon was punched out into the shape of a coin of 14 mm in diameter. The resultant was vacuum-dried at 100° C. for 2 hours to form a coin-shaped electrode. In this coin-shaped electrode, the silicon element serves as an active material.

(2) Formation of a Metal Li Electrode

In an argon box, a Li foil of 2 mm in thickness was expanded with a cylindrical_rod made of SUS to a thickness of 0.5 mm. Further, the foil was punched out into the shape of a coin of 16 mm in diameter to prepare a Li electrode for a counter electrode.

(3) Coin-Shaped Si Electrode-Li Counter Electrode Battery

The coin-shaped Si electrode for a positive electrode, the coin-shaped counter electrode Li electrode for a negative electrode, which were obtained as described above, and a separator made of a microporous polypropylene film of 25 μm in thickness and 16 mm in diameter were laminated in the order of the negative electrode, the separator, and the positive electrode, and were put in a 2032-size stainless steel battery can (a negative electrode can). Thereafter, 30 μL of the nonaqueous electrolyte solution was infused into the separator, and onto the resultant laminate were put a plate made of SUS and a spring. Lastly, the resultant was covered with a positive electrode can of the battery interleaving a gasket made of polypropylene. A can lid was caulked to keep the inside of the battery airtight. In this way, a coin-shaped battery of 20 mm in diameter and 3.2 mm in height was obtained. A charge/discharge cycle test as described below was conducted on the coin-shaped battery.

(4) Test Conditions for the Charge/Discharge Cycle Test

A charge/discharge cycle test was conducted on the coin-shaped Si electrode-Li counter electrode battery formed as described above.

### (Discharging Conditions)

In this battery, discharging is first conducted in order to insert Li into the Si electrode. The battery was discharged down to 0.1 V at a constant current of 0.7 mA, and thereafter the battery was discharged at a constant voltage of 0.1 V until the current became 0.07 mA.

### (Charging Conditions)

The battery was charged up to 1.2 V at a constant current of 0.7 mA, and thereafter the battery was charged at a constant voltage of 1.2 V until the current became 0.07 mA.

The charge capacities after the first cycle and after the 100th cycle were measured, and the cycle capacity maintenance ratio (%) of the coin-shaped Si electrode-Li counter electrode battery was calculated by a formula described below. The results are shown in Table 3.

Cycle capacity maintenance ratio of the coin-shaped Si electrode-Li counter electrode battery (%)=(charge capacity at the 100th cycle)/(charge capacity at the 1st cycle)×100 (%)

TABLE 3

| | Nonaqueous | Charge capacity | Cycle capacity |
|---|---|---|---|
| | electrolyte | at the 1st cycle | maintenance ratio |
| | solution No. | [mAh] | [%] (100th cycle) |
| Example 16 | 1 | 2 | 77 |
| Example 17 | 3 | 2.1 | 77 |
| Example 18 | 4 | 2.2 | 76 |
| Comparative | 16 | 2.2 | 40 |
| example 6 | | | |

6. Evaluation Results for Si Electrode-Li Counter Electrode Battery Test

Examples 16 to 18 have superior cycle capacity maintenance ratios to that of Comparative Example 6. From this result, it is evident that the electrolyte solution of the invention also contributes to an improvement in cycle characteristic in the Si electrode, as is the case with the Al electrode.

1. A nonaqueous electrolyte solution comprising a nonaqueous solvent, the nonaqueous solvent comprising a fluorinated solvent including a linear fluorinated carbonate (a1) and a fluorinated ethylene carbonate (a2), wherein the total amount of the fluorinated solvent in the nonaqueous solvent is in the range of from 50 to 100 weight %.

2. The nonaqueous electrolyte solution of claim 1, wherein the total amount of the fluorinated ethylene carbonate (a2) in the nonaqueous solvent is from 0.5 to 50 weight %.

3. The nonaqueous electrolyte solution of claim 1, wherein the fluorinated ethylene carbonate (a2) is 4-fluoroethylene carbonate.

4. The nonaqueous electrolyte solution of claim 1, wherein the linear fluorinated carbonate (a1) has fluorine atom(s) only at the end(s) of the chain thereof.

5. The nonaqueous electrolyte solution of claim 4, wherein the linear fluorinated carbonate (a1) has fluorine atom(s) only at a single end of the chain thereof.

6. A lithium secondary battery comprising: the nonaqueous electrolyte solution of claim 1; a positive electrode comprising a positive electrode active material that is capable of reversible electrochemical reaction with lithium ions; and a negative electrode comprising a negative electrode active material that is capable of charging and removing the charge from lithium ions.

7. The lithium secondary battery of claim 6, wherein the negative electrode active material is at least one of Al, Si, Sn, Sb or Ge.

8. The nonaqueous electrolyte solution of claim 2, wherein the fluorinated ethylene carbonate (a2) is 4-fluoroethylene carbonate.
